(19) United States
(12) Patent Application Publication
(10) Pub. No.: US 2026/0234864 A1
(43) Pub. Date: Aug. 13, 2026

(54) FABRIC TREATMENT METHOD AND FABRIC SIZING SLURRY

(71) Applicant: Yun Jing, Shanghai (CN)

(72) Inventors: Yun Jing, Shanghai (CN); Xiaojing Li, Suzhou, JS (CN)

(21) Appl. No.: 19/154,611

(22) PCT Filed: Mar. 29, 2024
(86) PCT No.: PCT/CN2024/084674

§ 371 Date: Aug. 7, 2025

(30) Foreign Application Priority Data
Feb. 14, 2023 (CN) 202310106906.0

(51) Int. Cl. D06M 15/263; C08F 8/42; D06B 3/18; D06M 15/71

(52) U.S. Cl. CPC D06M 15/263; C08F 8/42; D06B 3/18; D06M 15/71; D06M 2200/40

(57) ABSTRACT

The present disclosure discloses a fabric treatment method and a fabric sizing slurry. The treatment method includes: sizing a fabric with a sizing slurry, wherein the sizing slurry contains a modified poly(methyl acrylate). The modified poly(methyl acrylate) is prepared by the following method: mixing poly(methyl acrylate), a specific silicon-containing compound, and a specific sulfur-containing compound to perform a transesterification reaction to generate a modified intermediate, and then subjecting platinum ions to perform a complexation reaction with sulfur in the molecular chains of the modified intermediate to generate the modified poly(methyl acrylate). The method of the present disclosure enables the sized fabric to possess both high strength and long-lasting, uniform antibacterial properties, solving the problem in the prior art of having to address one aspect at the expense of the other.

### CROSS-REFERENCE TO RELATED APPLICATIONS

This application is U.S. national phase under 35 U.S.C. § 371 of International Patent Application No. PCT/CN2024/084674, filed on Mar. 29, 2024, which claims priority to Chinese Application No. 202310106906.0, filed on Feb. 14, 2023, the contents of all of which are incorporated by reference in their entirety.

### TECHNICAL FIELD

The present disclosure relates to the technical field of treating fibers or fabrics, and more particularly to the treatment of fibers or fabrics with a long-lasting antibacterial polymer, which imparts long-lasting antibacterial properties to the fibers or fabrics while enhancing their elasticity, toughness, and strength. Specifically, it relates to a fabric treatment method and a fabric sizing slurry.

### BACKGROUND

Poly(methyl acrylate) is a type of polyacrylate polymer, often used as a treatment agent for fabrics, leather, and paper, and as an adhesive. It is used for sizing the warp yarns of fabrics such as polyester/cotton and polyester/acrylic blends, where it can enhance the elasticity and toughness of the fabric. However, poly(methyl acrylate) has low strength and poor wear resistance. Meanwhile, in the social context of normalized COVID-19 pandemic management, the demand for antibacterial properties has surged. By adding antibacterial agent formulations to the slurry, the fabric can also be given antibacterial properties after sizing.

Currently, the method to increase strength is by adding a strength enhancer (such as silica or aluminum salts) to the poly(methyl acrylate) slurry, which strengthens the fabric after sizing. The method to add antibacterial function is by adding an antibacterial and antiseptic agent formulation to the poly(methyl acrylate) slurry, which imparts antibacterial properties to the fabric after sizing. However, it has been found in practice that when the above two methods are used simultaneously, the following problem exists: the strength enhancer forms a barrier layer on the fabric surface, which causes the antibacterial agent to be trapped inside the fabric, resulting in almost no antibacterial effect on the fabric surface. This makes it difficult to achieve both fabric strength and antibacterial performance.

### SUMMARY

An object of the present disclosure is to overcome one or more of the deficiencies in the prior art by providing an improved method for treating a fabric. The method uses a sizing slurry containing a specific modified poly(methyl acrylate) for sizing the fabric, such that the sized fabric simultaneously possesses high strength and long-lasting, uniform antibacterial properties, solving the trade-off problem existing in the prior art.

The present disclosure also provides a fabric sizing slurry which contains the specific modified poly(methyl acrylate).

To achieve the above object, a technical solution adopted by the present disclosure is:
a fabric treatment method, the treatment method comprising: sizing the fabric with a sizing slurry, wherein the sizing slurry comprises a modified poly(methyl acrylate), the modified poly(methyl acrylate) being prepared by: mixing poly(methyl acrylate), a compound of formula (I), and a compound of formula (II) to perform a transesterification reaction to form a modified intermediate, and then subjecting platinum ions to perform a complexation reaction with sulfur in molecular chains of the modified intermediate to form the modified poly(methyl acrylate), the platinum ions being obtained by oxidizing nanoplatinum with a peroxide;

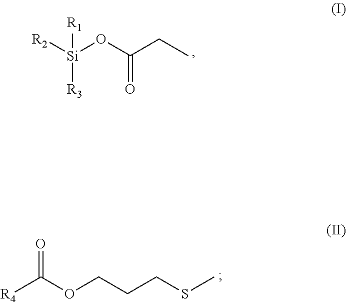

wherein, R₁, R₂, R₃, and R₄ are each independently selected from an unsubstituted C₁₋₆ alkyl, or a C₁₋₆ alkyl substituted with one or more substituents selected from halogen, C₁₋₃ alkyl, and phenyl.

In the present disclosure, some of the methyl ester groups on the molecular chains of poly(methyl acrylate) undergo a transesterification reaction with the compound of formula (I), thereby attaching silicon-containing groups to the side chains of the molecules. Some methyl ester groups also undergo a transesterification reaction with the compound of formula (II), thereby attaching sulfur-containing groups to the side chains of the molecules. The sulfur bears a lone pair of electrons. Nanoplatinum reacts with a peroxide and is oxidized to platinum ions, which have empty orbitals and can form a complex with the sulfur of the thioether, which has a lone pair of electrons. This results in the molecular chains carrying platinum ions. The platinum ions can also serve as linking agents to connect multiple poly(methyl acrylate) molecular chains that have sulfur-containing groups attached.

An exemplary reaction process is as follows:

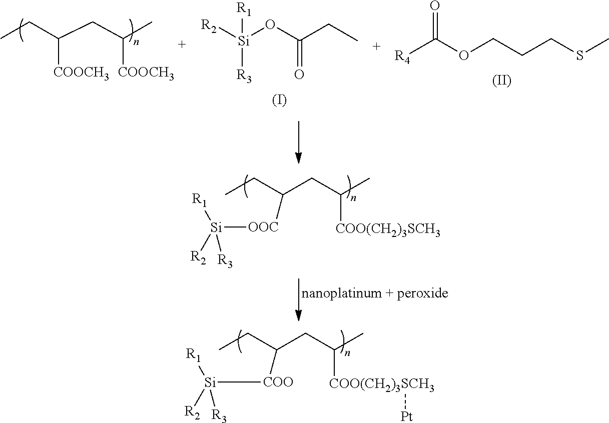

In this reaction process, it is merely shown as an example that two adjacent methyl ester groups react with one of the compound of formula (I) and one of the compound of formula (II) respectively through transesterification, followed by the complexation of platinum ions with the sulfur in the molecular chains. This allows the platinum ions to be uniformly dispersed in the system and firmly bonded to the molecular chains. Of course, it is also possible that multiple adjacent methyl ester groups all react with either the compound of formula (I) or the compound of formula (II). That is, in reality, the modified poly(methyl acrylate) is not a single molecular structure but exists as multiple molecular structures. The difference between the various molecular structures arises from which compound, the one of formula (I) or the one of formula (II), the methyl ester groups react with through transesterification.

According to some and specific aspects of the present disclosure, R₁, R₂, R₃, and R₄ are each independently selected from methyl, ethyl, propyl, monochloromethyl, monobromomethyl, dichloromethyl, dibromomethyl, trichloromethyl or tribromomethyl.

According to a specific aspect of the present disclosure, the compound of formula (I) is trimethylsilyl propionate, and the compound of formula (II) is 3-(methylthio) propyl acetate.

According to some aspects of the present disclosure, the transesterification reaction is carried out under alkaline conditions, at a reaction temperature of 65-85° C., and in a solvent.

According to some aspects of the present disclosure, the alkaline conditions are formed by adding an alkaline substance, the alkaline substance comprising sodium acetate, potassium acetate, sodium carbonate or potassium carbonate.

According to some aspects of the present disclosure, the solvent is n-heptane.

According to some aspects of the present disclosure, a feeding mass ratio of the poly(methyl acrylate) to the solvent to the alkaline substance is 1:0.5-1.8:0.001-0.01.

According to some aspects of the present disclosure, a feeding mass ratio of the poly(methyl acrylate) to the compound of formula (I) to the compound of formula (II) is 1:0.1-0.35:0.1-0.38.

According to the present disclosure, the poly(methyl acrylate) can be commercially obtained.

A method for preparing the poly(methyl acrylate) comprises:
removal of polymerization inhibitor: adding an aqueous sodium hydroxide solution to methyl acrylate (commercially available methyl acrylate generally contains a polymerization inhibitor), stirring, and separating out the water;
adding an emulsifier and sodium bicarbonate to deionized water, and under a nitrogen atmosphere at a temperature of 70-90° C., adding the methyl acrylate from which the polymerization inhibitor has been removed and an initiator while stirring to react; after the reaction is completed, restoring the temperature to room temperature, washing with pure water, and separating out a white milky substance with a filter cloth to obtain the poly(methyl acrylate).

In some embodiments of the present disclosure, during the preparation of the poly(methyl acrylate), the emulsifier can be alkylphenol polyoxyethylene ether (OP-10).

In some embodiments of the present disclosure, during the preparation of the poly(methyl acrylate), the initiator can be tert-butyl hydroperoxide (TBHP).

According to some aspects of the present disclosure, the complexation reaction is carried out at a reaction temperature of 35-45° C.

According to some aspects of the present disclosure, the peroxide is added in the form of an aqueous solution of the peroxide.

According to some and specific aspects of the present disclosure, the peroxide is peracetic acid, and the peracetic acid is added in the form of an aqueous peracetic acid solution.

In some embodiments of the present disclosure, an embodiment for preparing the platinum ions comprises: mixing an aqueous nanoplatinum solution with an aqueous peracetic acid solution to perform an oxidation reaction to form the platinum ions.

According to some aspects of the present disclosure, a method for preparing the aqueous nanoplatinum solution comprises: reacting potassium chloroplatinate, sodium borohydride, citric acid, and lactic acid in water under the protection of a protective gas, in the presence of polyvinylpyrrolidone, and under heating conditions, to form nanoplatinum precursor particles, separating the nanoplatinum precursor particles and dispersing the nanoplatinum precursor particles in water, performing ultrasonic oscillation, and then irradiating with ultraviolet light with a wavelength of 200-350 nm to obtain the aqueous nanoplatinum solution.

Further, during the preparation of the aqueous nanoplatinum solution, a feeding mass ratio of the potassium chloroplatinate to the sodium borohydride to the citric acid to the lactic acid to the polyvinylpyrrolidone is 1:10-16:25-35:10-20:20-30.

Further, during the preparation of the aqueous nanoplatinum solution, the heating conditions enable the reaction to proceed at a temperature of 55-65° C. According to some aspects of the present disclosure, a content of the nanoplatinum in the aqueous nanoplatinum solution is 0.01-5 mg/mL.

In some embodiments of the present disclosure, during the preparation of the aqueous nanoplatinum solution, the protective gas can be nitrogen, helium, etc.

According to some and specific aspects of the present disclosure, a particle size of the nanoplatinum is 3-8 nm.

According to some aspects of the present disclosure, a feeding mass ratio of the nanoplatinum to the compound of formula (II) is 0.000005-0.000015:1.

According to some aspects of the present disclosure, by mass percentage, an added amount of the peroxide is 0.05%-0.15% of a mass of the modified intermediate. According to some aspects of the present disclosure, by mass percentage, in the sizing slurry, the modified poly(methyl acrylate) accounts for 45%-70%.

According to some aspects of the present disclosure, by mass percentage, the sizing slurry comprises: 45%-70% of modified poly(methyl acrylate), 10%-35% of methyl acrylate, 1%-10% of acrylonitrile, and 1%-10% of sodium acrylate.

Further, by mass percentage, the sizing slurry comprises: 50%-70% of modified poly(methyl acrylate), 15%-35% of methyl acrylate, 2%-10% of acrylonitrile, and 2%-10% of sodium acrylate.

In some embodiments of the present disclosure, the sizing treatment can be performed by a single-immersion double-pressure method, i.e., one immersion and two pressures, and the immersion time can be adjusted.

In some embodiments of the present disclosure, the sizing treatment is performed on a Karl Mayer double-size-slot sizing machine with the following parameters: a sizing speed of 30-60 m/min, a size-slot temperature of 50-60° C., a size pick-up of 8-15%, a main squeezing pressure of 15-30 kN, and an auxiliary squeezing pressure of 6-15 kN.

In some embodiments of the present disclosure, the method of treating the fabric further comprises drying after the sizing. The drying method includes but is not limited to using an infrared dryer, a drying temperature can be 100-120° C., and a drying time can be 20-60 min.

Another technical solution provided by the present disclosure is: a fabric sizing slurry, wherein the fabric sizing slurry is the sizing slurry used in the method for treating a fabric as described above.

Another technical solution provided by the present disclosure is: a fabric sizing slurry, wherein, by mass percentage, the sizing slurry comprises: 45%-70% of modified poly(methyl acrylate), 10%-35% of methyl acrylate, 1%-10% of acrylonitrile, and 1%-10% of sodium acrylate;
the modified poly(methyl acrylate) is prepared by: mixing poly(methyl acrylate), a compound of formula (I), and a compound of formula (II) to perform a transesterification reaction to form a modified intermediate, and then subjecting platinum ions to perform a complexation reaction with sulfur in molecular chains of the modified intermediate to form the modified poly(methyl acrylate), the platinum ions being obtained by oxidizing nanoplatinum with a peroxide;

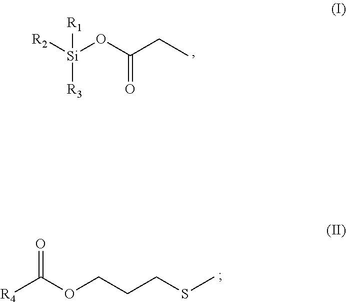

wherein, R₁, R₂, R₃, and R₄ are each independently selected from an unsubstituted C₁₋₆ alkyl, or a C₁₋₆ alkyl substituted with one or more substituents selected from halogen, C₁₋₃ alkyl, and phenyl.

Due to the application of the above technical solutions, the present disclosure has the following advantages over the prior art:
based on the trade-off problem that exists when treating existing fibers or their products with poly(methyl acrylate), the present disclosure innovatively introduces silyl ester groups and sulfur-containing groups with certain chain segments into the molecular chains of poly(methyl acrylate) through a transesterification reaction. This not only improves strength but also makes the slurry layer formed after drying more resistant to friction, maintaining long-lasting performance. In particular, the introduction of sulfur-containing groups enables the modified polyacrylate of the present disclosure to combine with nanoplatinum, allowing platinum ions to be complexed into the polymer chains. Because they are combined in a complexed form, the platinum ions can maintain high dispersibility in the system, thereby preserving their corresponding efficacy, such as achieving a lasting antibacterial effect. The high dispersibility also ensures that the antibacterial effect is uniform and balanced throughout the entire fabric. Furthermore, the introduction of platinum ions does not bring about interference from other colors, allowing the slurry layer to maintain its original color state and reducing negative impacts on the fabric and its products. In addition, the present disclosure achieves increased strength without reducing the antibacterial effect, realizing a balance between the two and solving the trade-off problem present in the prior art.

### DETAILED DESCRIPTION

The following specific embodiments are provided to further illustrate the above solutions. It should be understood that these embodiments are intended to illustrate the basic principles, main features, and advantages of the present disclosure, and the scope of the present disclosure is not limited by the following embodiments. The implementation conditions used in the embodiments can be further adjusted according to specific requirements; implementation conditions not specified are generally those in conventional experiments.

Unless otherwise specified in the following embodiments, all raw materials are commercially available or prepared by conventional methods in the art.

The aqueous nanoplatinum solution used in the following embodiments is prepared by the following method: 1 g of potassium chloroplatinate, 12 g of sodium borohydride, 25 g of polyvinylpyrrolidone (purchased from Shanghai Aladdin, K29-32), 30 g of citric acid, and 15 g of lactic acid are added to 1 L of deionized water. The mixture is stirred and reacted under heating at 60° C. for 2.5 hours to generate nanoplatinum precursor particles. During the reaction, nitrogen gas is continuously supplied as an inert protective gas. The solution after heating is then purified by column chromatography to remove reaction impurities. The purified nanoplatinum precursor particles are dispersed in an appropriate amount of deionized water and subjected to ultrasonic oscillation for 30 minutes with a 30 kHz sonic wave. Then, the solution is irradiated with ultraviolet light at a wavelength of 300 nm for 10 minutes to prepare the aqueous nanoplatinum solution. The average particle size of the nanoplatinum prepared by this method is about 5 nm, and the content of nanoplatinum in the aqueous nanoplatinum solution is 0.2 mg/mL.

The poly(methyl acrylate) used in the following embodiments is prepared by the following method:
removal of polymerization inhibitor: 400 g of methyl acrylate is mixed with a 5% by mass aqueous sodium hydroxide solution (volume ratio of methyl acrylate to 5% aqueous sodium hydroxide solution is 5:1), stirred for 10 hours, and the water is separated. 4 g of alkylphenol polyoxyethylene ether (OP-10) and 2 g of sodium bicarbonate are added to 500 mL of deionized water. At a temperature of 80° C. and under a nitrogen atmosphere, the methyl acrylate from which the polymerization inhibitor has been removed and 1 g of tert-butyl hydroperoxide (TBHP) are added while stirring. The reaction proceeds for 5 hours. After the reaction is completed, the temperature is restored to room temperature, washed with pure water, and a white milky substance is separated out with a filter cloth to obtain poly(methyl acrylate).

Methyl acrylate was purchased from Aladdin, analytical grade;
acrylonitrile was purchased from Aladdin, purity ≥99%;
sodium acrylate was purchased from Rhawn Chemistry, purity ≥95%;
alkylphenol polyoxyethylene ether (OP-10) was purchased from Wuhan Lannabai Pharmaceutical Chemical Co., Ltd., purity ≥99%;
tert-butyl hydroperoxide was purchased from Dongying Haijing Chemical Co., Ltd., purity ≥70%;
trimethylsilyl propionate was purchased from Aladdin, purity ≥95%;
3-(methylthio) propyl acetate was purchased from Aladdin, purity ≥99%;
peracetic acid was purchased from Jingmen Shuangxiong Biotechnology Co., Ltd., concentration: 15%.

### Embodiment 1

This example provides a fabric sizing slurry. By mass percentage, the fabric sizing slurry comprises: 50% of modified poly(methyl acrylate), 35% of methyl acrylate, 7% of acrylonitrile, and 8% of sodium acrylate.

The fabric sizing slurry is obtained by mixing the modified poly(methyl acrylate), methyl acrylate, acrylonitrile, and sodium acrylate according to the formulation amounts;
wherein, the modified poly(methyl acrylate) is prepared by the following method:
Step 1. 172 g of poly(methyl acrylate), 36.5 g of trimethylsilyl propionate, and 37 g of 3-(methylthio) propyl acetate are mixed and stirred uniformly. The solvent system is 250 mL of n-heptane. The catalyst for transesterification is 0.5 g of sodium acetate. The reaction temperature is 75° C. The mixture is stirred and reacted for 8 hours, cooled to room temperature, and a milky solid (modified intermediate) is separated out with a filter cloth, washed with pure water, washed with ethanol, and air-dried.
Step 2. 1.0 mL of peracetic acid (aqueous solution, 15% by mass percentage) is added to 10 mL of an aqueous nanoplatinum solution with a concentration of 0.2 mg/mL. After stirring, it is mixed with the modified intermediate from Step 1 and stirred in a 40° C. water bath for 30 minutes.
Step 3. The solvent is removed by vacuum distillation (8000 Pa, 40° C.) to obtain the modified poly(methyl acrylate).

### Embodiment 2

This example provides a fabric sizing slurry. By mass percentage, the fabric sizing slurry comprises: 60% of modified poly(methyl acrylate), 25% of methyl acrylate, 7% of acrylonitrile, and 8% of sodium acrylate;
The fabric sizing slurry is obtained by mixing the modified poly(methyl acrylate), methyl acrylate, acrylonitrile, and sodium acrylate according to the formulation amounts;
wherein, the modified poly(methyl acrylate) is prepared by the following method:
Step 1. 200 g of poly(methyl acrylate), 40 g of trimethylsilyl propionate, and 35 g of 3-(methylthio) propyl acetate are mixed and stirred uniformly. The solvent system is 280 mL of n-heptane. The catalyst for transesterification is 0.6 g of sodium acetate. The reaction temperature is 80° C. The mixture is stirred and reacted for 9 hours, cooled to room temperature, and a milky solid (modified intermediate) is separated out with a filter cloth, washed with pure water, washed with ethanol, and air-dried.
Step 2. 1.5 mL of peracetic acid (aqueous solution, 15% by mass percentage) is added to 12 mL of an aqueous nanoplatinum solution with a concentration of 0.2 mg/mL. After stirring, it is mixed with the modified intermediate from Step 1 and stirred in a 42° C. water bath for 45 minutes.
Step 3. The solvent is removed by vacuum distillation (8000 Pa, 40° C.) to obtain the modified poly(methyl acrylate).

### Embodiment 3

This example provides a fabric sizing slurry. By mass percentage, the fabric sizing slurry comprises: 70% of modified poly(methyl acrylate), 15% of methyl acrylate, 7% of acrylonitrile, and 8% of sodium acrylate;
The fabric sizing slurry is obtained by mixing the modified poly(methyl acrylate), methyl acrylate, acrylonitrile, and sodium acrylate according to the formulation amounts;
wherein, the modified poly(methyl acrylate) is prepared by the following method:
Step 1. 150 g of poly(methyl acrylate), 30 g of trimethylsilyl propionate, and 42 g of 3-(methylthio) propyl acetate are mixed and stirred uniformly. The solvent system is 220 mL of n-heptane. The catalyst for transesterification is 0.4 g of sodium acetate. The reaction temperature is 80° C. The mixture is stirred and reacted for 9 hours, cooled to room temperature, and a milky solid (modified intermediate) is separated out with a filter cloth, washed with pure water, washed with ethanol, and air-dried.
Step 2. 2.0 mL of peracetic acid (aqueous solution, 15% by mass percentage) is added to 14 mL of an aqueous nanoplatinum solution with a concentration of 0.2 mg/mL. After stirring, it is mixed with the modified intermediate from Step 1 and stirred in a 38° C. water bath for 37 minutes.
Step 3. The solvent and small molecule by-products are removed by vacuum distillation (8000 Pa, 40° C.) to obtain the modified poly(methyl acrylate).

### Comparative Embodiment 1

Basically the same as Embodiment 1, with the only difference being that the modified poly(methyl acrylate) is replaced with unmodified poly(methyl acrylate).

### Comparative Embodiment 2

Basically the same as Embodiment 1, with the only difference being that the modified poly(methyl acrylate) is replaced with unmodified poly(methyl acrylate), and silica and an antibacterial agent (nano-silver antibacterial agent) are added to the slurry.

### Comparative Embodiment 3

Basically the same as Embodiment 1, with the only difference being that 3-(methylthio) propyl acetate is not added during the preparation of the modified poly(methyl acrylate).

### Application Embodiment 1

This example provides a method for treating a fabric, wherein the fabric sizing slurry of Embodiment 1 is used to size a fabric. The raw material of the fabric is basically polyester staple fiber. The sizing process is carried out on a Karl Mayer double-size-slot sizing machine with the following parameters: sizing speed of 45 m/min, size-slot temperature of 55° C., size pick-up of 12.5%, main squeezing pressure of 22 kN, and auxiliary squeezing pressure of 11 kN. Then, drying is performed using an infrared dryer at a drying temperature of 110° C. for a drying time of 40 min to obtain the sized fabric.

### Application Embodiment 2

This example provides a method for treating a fabric, wherein the fabric sizing slurry of Embodiment 2 is used to size a fabric. The raw material of the fabric is basically polyester staple fiber. The sizing process is carried out on a Karl Mayer double-size-slot sizing machine with the following parameters: sizing speed of 45 m/min, size-slot temperature of 55° C., size pick-up of 12.5%, main squeezing pressure of 22 kN, and auxiliary squeezing pressure of 11 kN. Then, drying is performed using an infrared dryer at a drying temperature of 110° C. for a drying time of 40 min to obtain the sized fabric.

### Application Embodiment 3

This example provides a method for treating a fabric, wherein the fabric sizing slurry of Embodiment 3 is used to size a fabric. The raw material of the fabric is basically polyester staple fiber. The sizing process is carried out on a Karl Mayer double-size-slot sizing machine with the following parameters: sizing speed of 45 m/min, size-slot temperature of 55° C., size pick-up of 12.5%, main squeezing pressure of 22 kN, and auxiliary squeezing pressure of 11 kN. Then, drying is performed using an infrared dryer at a drying temperature of 110° C. for a drying time of 40 min to obtain the sized fabric.

### Comparative Application Embodiment 1

Basically the same as Application Embodiment 1, with the only difference being that the fabric sizing slurry of Comparative Embodiment 1 is used to size the fabric.

### Comparative Application Embodiment 2

Basically the same as Application Embodiment 1, with the only difference being that the fabric sizing slurry of Comparative Embodiment 2 is used to size the fabric.

### Comparative Application Embodiment 3

Basically the same as Application Embodiment 1, with the only difference being that the fabric sizing slurry of Comparative Embodiment 3 is used to size the fabric.

### Performance Testing:

The fabrics obtained from Application Embodiments 1-3 and Comparative Application Embodiments 1-3 were subjected to the following performance tests, with the specific results as follows:
Application Embodiment 1, Original breaking strength (cN): 1065, Breaking strength after sizing (cN): 1280, Enhancement rate: 20.19%, Antibacterial rate (initial): 99.6%, Antibacterial rate (after one year): 99.0%;
Wear resistance: Damage appeared after 2000 cycles of abrasion, pressure 12 kPa;
Application Embodiment 2, Original breaking strength (cN): 1065, Breaking strength after sizing (cN): 1290, Enhancement rate: 21.13%, Antibacterial rate (initial): 99.7%, Antibacterial rate (after one year): 99.1%;
Wear resistance: Damage appeared after 2000 cycles of abrasion, pressure 12 kPa;
Application Embodiment 3, Original breaking strength (cN): 1065, Breaking strength after sizing (cN): 1305, Enhancement rate: 22.54%, Antibacterial rate (initial): 99.9%, Antibacterial rate (after one year): 99.2%;
Wear resistance: Damage appeared after 2000 cycles of abrasion, pressure 12 kPa;
Comparative Application Embodiment 1, Original breaking strength (cN): 1065,
Breaking strength after sizing (cN): 1150, Enhancement rate: 7.98%, Antibacterial rate (initial): 0%;
Wear resistance: Damage appeared after 500 cycles of abrasion, pressure 12 kPa;
Comparative Application Embodiment 2, Original breaking strength (cN): 1065,
Breaking strength after sizing (cN): 1350, Enhancement rate: 26.76%, Antibacterial rate (initial): 66.7%, Antibacterial rate (after one year): 33.3%;
Wear resistance: Damage appeared after 2000 cycles of abrasion, pressure 12 kPa;
Comparative Application Embodiment 3, Original breaking strength (cN): 1065,
Breaking strength after sizing (cN): 1200, Enhancement rate: 12.68%, Antibacterial rate (initial): 50.0%, Antibacterial rate (after one year): 31.2%;
Wear resistance: Damage appeared after 1500 cycles of abrasion, pressure 12 kPa.

The testing methods for the above properties are as follows: The breaking strength is measured according to GB/T 3923-2013 “Textiles—Tensile properties of fabrics”, and the enhancement rate=(Breaking strength after sizing−Original breaking strength)/Original breaking strength×100%.

The antibacterial performance is tested according to GB/T 20944.2-2007 “Textiles—Evaluation for antibacterial activity—Part 2: Absorption method”.

The wear resistance is determined according to GB/T 21196 “Textiles—Determination of abrasion resistance of fabrics by the Martindale method”.

As can be seen from the above, compared with the embodiments, in Comparative Embodiment 1, where the modified poly(methyl acrylate) was replaced with unmodified poly(methyl acrylate), the performance in terms of wear resistance and antibacterial properties was poor. In Comparative Embodiment 2, although good wear resistance was obtained by adding silica and an antibacterial agent, both the antibacterial property and its durability were poor. In Comparative Embodiment 3, where 3-(methylthio) propyl acetate was not added during the preparation of the modified poly(methyl acrylate), not only did the wear resistance decrease significantly, but the antibacterial property and its durability were also poor.

The above embodiments are only for illustrating the technical concept and features of the present disclosure, and their purpose is to enable those skilled in the art to understand the content of the present disclosure and implement it accordingly. They should not be used to limit the protection scope of the present disclosure. Any equivalent changes or modifications made in accordance with the spirit and substance of the present disclosure shall be covered by the protection scope of the present disclosure.

The endpoints and any values of the ranges disclosed herein are not limited to the precise range or value, and these ranges or values should be understood to include values close to these ranges or values. For numerical ranges, the endpoint values of each range, the endpoint values and individual point values of each range, and the individual point values can be combined with each other to obtain one or more new numerical ranges, which should be considered as specifically disclosed herein.

1. (canceled)

2. A fabric treatment method, the treatment method comprising: sizing the fabric with a sizing slurry, wherein the sizing slurry comprises a modified poly(methyl acrylate), the modified poly(methyl acrylate) being prepared by: mixing poly(methyl acrylate), a compound of formula (I), and a compound of formula (II) to perform a transesterification reaction to form a modified intermediate, and then subjecting platinum ions to perform a complexation reaction with sulfur in molecular chains of the modified intermediate to form the modified poly(methyl acrylate), the platinum ions being obtained by oxidizing nanoplatinum with a peroxide; 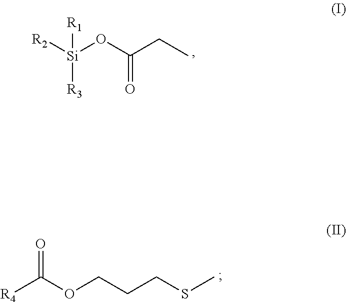
wherein, R₁, R₂, R₃, and R₄ are each independently selected from an unsubstituted C₁₋₆ alkyl, or a C₁₋₆ alkyl substituted with one or more substituents selected from halogen, C₁₋₃ alkyl, and phenyl.

3. The fabric treatment method according to claim 2, wherein R₁, R₂, R₃, and R₄ are each independently selected from methyl, ethyl, propyl, monochloromethyl, monobromomethyl, dichloromethyl, dibromomethyl, trichloromethyl, or tribromomethyl.

4. The fabric treatment method according to claim 3, wherein the compound of formula (I) is trimethylsilyl propionate, and the compound of formula (II) is 3-(methylthio) propyl acetate.

5. The fabric treatment method according to claim 2, wherein the transesterification reaction is carried out under alkaline conditions, at a reaction temperature of 65-85° C., and in a solvent;
and/or, a feeding mass ratio of the poly(methyl acrylate) to the compound of formula (I) to the compound of formula (II) is 1:0.1-0.35:0.1-0.38;
and/or, the complexation reaction is carried out at a reaction temperature of 35-45° C.;
and/or, a particle size of the nanoplatinum is 3-8 nm.

6. The fabric treatment method according to claim 5, wherein the alkaline conditions are formed by adding an alkaline substance, the alkaline substance comprising sodium acetate, potassium acetate, sodium carbonate or potassium carbonate;
and/or, the solvent is n-heptane.

7. (canceled)

8. The fabric treatment method according to claim 6, wherein a feeding mass ratio of the poly(methyl acrylate) to the solvent to the alkaline substance is 1:0.5-1.8:0.001-0.01.

9. (canceled)

10. (canceled)

11. (canceled)

12. The fabric treatment method according to claim 2, wherein the peroxide is peracetic acid, and the peracetic acid is added in the form of an aqueous peracetic acid solution; an embodiment for preparing the platinum ions comprises: mixing an aqueous nanoplatinum solution with an aqueous peracetic acid solution to perform an oxidation reaction to form the platinum ions.

13. The fabric treatment method according to claim 12, wherein a method for preparing the aqueous nanoplatinum solution comprises: reacting potassium chloroplatinate, sodium borohydride, citric acid, and lactic acid in water under the protection of a protective gas, in the presence of polyvinylpyrrolidone, and under heating conditions, to form nanoplatinum precursor particles, separating the nanoplatinum precursor particles and dispersing the nanoplatinum precursor particles in water, performing ultrasonic oscillation, and then irradiating with ultraviolet light with a wavelength of 200-350 nm to obtain the aqueous nanoplatinum solution.

14. The fabric treatment method according to claim 13, wherein a feeding mass ratio of the potassium chloroplatinate to the sodium borohydride to the citric acid to the lactic acid to the polyvinylpyrrolidone is 1:10-16:25-35:10-20:20-30;
and/or, the heating conditions enable the reaction to proceed at a temperature of 55-65° C.;
and/or, a content of the nanoplatinum in the aqueous nanoplatinum solution is 0.01-5 mg/mL;
and/or, the protective gas is nitrogen or an inert gas, the inert gas comprising helium.

15. (canceled)

16. (canceled)

17. (canceled)

18. The fabric treatment method according to claim 2, wherein a feeding mass ratio of the nanoplatinum to the compound of formula (II) is 0.000005-0.000015:1.

19. The fabric treatment method according to claim 2, wherein, by mass percentage, an added amount of the peroxide is 0.05%-0.15% of a mass of the modified intermediate.

20. The fabric treatment method according to claim 2, wherein a method for preparing the poly(methyl acrylate) comprises:
adding an aqueous sodium hydroxide solution to methyl acrylate, stirring, and separating out water;
adding an emulsifier and sodium bicarbonate to deionized water, and under a nitrogen atmosphere at a temperature of 70-90° C., adding the treated methyl acrylate and an initiator while stirring to react, after the reaction is completed, restoring the temperature to room temperature, washing with pure water, and separating out a white emulsion with a filter cloth to obtain the poly(methyl acrylate).

21. The fabric treatment method according to claim 20, wherein in the process of preparing the poly(methyl acrylate), the emulsifier comprises alkylphenol polyoxyethylene ether, and the initiator comprises tert-butyl hydroperoxide.

22. The fabric treatment method according to claim 2, wherein, by mass percentage, the modified poly(methyl acrylate) accounts for 45%-70% of the sizing slurry.

23. The fabric treatment method according to claim 22, wherein, by mass percentage, the sizing slurry comprises: 45%-70% of the modified poly(methyl acrylate), 10%-35% of methyl acrylate, 1%-10% of acrylonitrile, and 1%-10% of sodium acrylate.

24. The fabric treatment method according to claim 23, wherein, by mass percentage, the sizing slurry comprises: 50%-70% of the modified poly(methyl acrylate), 15%-35% of methyl acrylate, 2%-10% of acrylonitrile, and 2%-10% of sodium acrylate.

25. The fabric treatment method according to claim 2, wherein the sizing is performed by a single-immersion double-pressure method, the single-immersion double-pressure method being one immersion and two pressures.

26. The fabric treatment method according to claim 2, wherein the sizing is performed on a Karl Mayer double-size-slot sizing machine with the following parameters: a sizing speed of 30-60 m/min, a size-slot temperature of 50-60° C., a size pick-up of 8-15%, a main squeezing pressure of 15-30 kN, and an auxiliary squeezing pressure of 6-15 kN.

27. The fabric treatment method according to claim 2, wherein the method of treating the fabric further comprises drying after the sizing, the drying is performed using an infrared dryer, a drying temperature is 100-120° C., and a drying time is 20-60 min.

28. (canceled)

29. A fabric sizing slurry, wherein, by mass percentage, the sizing slurry comprises: 45%-70% of modified poly(methyl acrylate), 10%-35% of methyl acrylate, 1%-10% of acrylonitrile, and 1%-10% of sodium acrylate;
the modified poly(methyl acrylate) is prepared by: mixing poly(methyl acrylate), a compound of formula (I), and a compound of formula (II) to perform a transesterification reaction to form a modified intermediate, and then subjecting platinum ions to perform a complexation reaction with sulfur in molecular chains of the modified intermediate to form the modified poly(methyl acrylate), the platinum ions being obtained by oxidizing nanoplatinum with a peroxide; 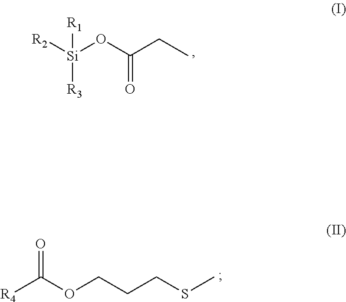
wherein, R₁, R₂, R₃, and R₄ are each independently selected from an unsubstituted C₁₋₆ alkyl, or a C₁₋₆ alkyl substituted with one or more substituents selected from halogen, C₁₋₃ alkyl, and phenyl.
